(19) United States
(12) Patent Application Publication
(10) Pub. No.: US 2002/0018555 A1
(43) Pub. Date: Feb. 14, 2002

(54) Method of detecting a frequency or a combination of frequencies in a signal and telecommunication equipment using the method

(75) Inventor: Baptistine Charbin-Pramayon, Chatou (FR)

Correspondence Address: SUGHRUE, MION, ZINN, MACPEAK & SEAS, PLLC, 2100 Pennsylvania Avenue, N.W., Washington, DC, 20037-3213, US

(73) Assignee: ALCATEL

(21) Appl. No.: 09/885,169

(22) Filed: Jun. 21, 2001

(30) Foreign Application Priority Data
Jun. 22, 2000 (FR) 00 08 014

(51) Int. Cl. H04M 1/00; H04M 3/00

(52) U.S. Cl. 379/346

(57) ABSTRACT

A method of detecting a frequency or a combination of frequencies in a signal by processing the signal by means of an appropriate algorithm includes an operation of estimating filter coefficients for characterizing the signal using a least mean squares algorithm and an operation of computing a Euclidean distance between the signal to which the detection method is applied and at least the frequency or combination of frequencies to be detected using the filter coefficients obtained for the signal to which the detection method is applied by the estimation operation and the same number of corresponding particular filter coefficients that characterize the frequency or combination of frequencies to be detected. That frequency or combination of frequencies is considered as having been detected in the signal to which the detection method is applied if the computed Euclidean distance is below a particular threshold value.

### CROSS-REFERENCE TO RELATED APPLICATIONS

This application is based on French Patent Application No. 00 08 014 filed Jun. 22, 2000, the disclosure of which is hereby incorporated by reference thereto in its entirety, and the priority of which is hereby claimed under 35 U.S.C. §119.

### BACKGROUND OF THE INVENTION

1. Field of the Invention

The invention relates to a method of detecting a frequency or a combination of frequencies in a signal which may temporarily include those frequencies and/or multifrequency combinations, in particular for signaling and/for transmitting information between equipment units of a telecommunication system.

It also relates to telecommunication equipment in which or by means of which the above method can be implemented.

2. Description of the Prior Art

Transmitting signaling indications or information elements in a signal in the form of predetermined frequencies or combinations of frequencies has long been used in various real time systems and in particular in telecommunication systems. It requires the receiving equipment to be able to detect in a signal transmitted to it the presence of a frequency or a combination of frequencies characteristic of a signaling indication or of an information element. Fast detection is generally required if a frequency or frequency combination to be looked for occurs in a signal to which the detection method is applied. It is also advantageous for detection to be assured over a wide dynamic power range and not to be disrupted by the presence in the signal to which the detection method is applied of other characteristic frequencies or combinations of frequencies or of frequency components relating to noise or transmitted speech signals. The characteristic frequencies and combinations of frequencies, including those searched for, are chosen in a manner that is known to the skilled person so that they cannot be confused with each other or with other signals that might appear in the signal to which the detection method is applied.

One prior art method of detecting a particular frequency or multifrequency combination uses a GOERTZEL algorithm in the course of operations effected on the signal to which the detection method is applied. This method is used in particular to detect characteristic combinations of two frequencies of dual-tone multi-frequency (DTMF) signaling, which is routinely used in the field of telecommunications. It enables the energy level obtained for a signal to which the detection method is applied to be determined at each frequency of two groups each of four frequencies that are characteristic of that signaling mode and the frequency in each group with the highest received energy level to be deduced therefrom. The DTMF combination transmitted is that defined by the two frequencies, one in each group, that have the highest energy level. However, a drawback of the above method is that it cannot provide as wide a dynamic range as would be desirable, extending from 0 to −40 dBm, for example.

Using algorithms exploiting filters whose center frequencies are the frequencies to be detected and analyzing the energy obtained at the output of the filters is also known in the art. The drawback is that the response time cannot be as fast as would be desirable, for example of the order of 10 milliseconds.

Another feasible solution is using parametric methods which produce a spectral analysis of a signal to which the detection method is applied and use matrix inversion computation. However, this solution is not suitable for real time applications.

### SUMMARY OF THE INVENTION

The invention therefore proposes a method of detecting a frequency or a combination of frequencies in a signal by processing the signal by means of an appropriate algorithm, which method includes an operation of estimating filter coefficients for characterizing the signal using a least mean squares algorithm and an operation of computing a Euclidean distance between the signal to which the detection method is applied and at least the frequency or combination of frequencies to be detected using the filter coefficients obtained for the signal to which the detection method is applied by the estimation operation and the same number of corresponding particular filter coefficients that characterize the frequency or combination of frequencies to be detected, the frequency or combination of frequencies being considered as having been detected in the signal to which the detection method is applied if the computed Euclidean distance is below a particular threshold value.

In one embodiment of the method according to the invention the threshold value corresponds to a Euclidean distance between the signal to which the detection method is applied and a particular signal normally included in the signal to which the detection method is applied, the distance being computed using the filter coefficients obtained for the signal to which the detection method is applied by the estimation operation and the same number of corresponding predetermined filter coefficients that characterize the particular signal.

In one embodiment of the method according to the invention the particular signal taken into account in determining the Euclidean distance constituting the threshold value is a white noise signal.

Another embodiment of the method according to the invention includes computing at least one additional Euclidean distance between the signal to which the detection method is applied and another particular signal likely to be contained in the signal to which the detection method is applied to constitute an additional threshold value which is compared with the estimated Euclidean distance between the signal to which the detection method is applied and the frequency or combination of frequencies to be detected.

The invention also provides telecommunication equipment, in particular telephone and/or mobile telephone signaling processing equipment, including a signal processor programmed to implement the above detection method.

The invention also provides telecommunication equipment, in particular telephone and/or mobile telephone signaling processing equipment, including a signal processor programmed to implement the detection method defined hereinabove.

The invention, its features and its advantages are explained in the following description, which is given with reference to the drawings listed below.

### BRIEF DESCRIPTION OF THE DRAWINGS

FIG. 1 is a diagram relating to an algorithm used in a detection method according to the invention.

FIG. 2 is a diagram showing a multifrequency signal consisting of a particular combination of two frequencies and three power levels and in which the number of coefficients is plotted on the abscissa axis and the amplitude of the signal is plotted on the ordinate axis.

FIG. 3 is a diagram showing two different multifrequency signals including the combination of two frequencies shown in FIG. 1 and a second combination of two frequencies, subject to the same conditions as apply to FIG. 1.

### DETAILED DESCRIPTION OF THE PREFERRED EMBODIMENT

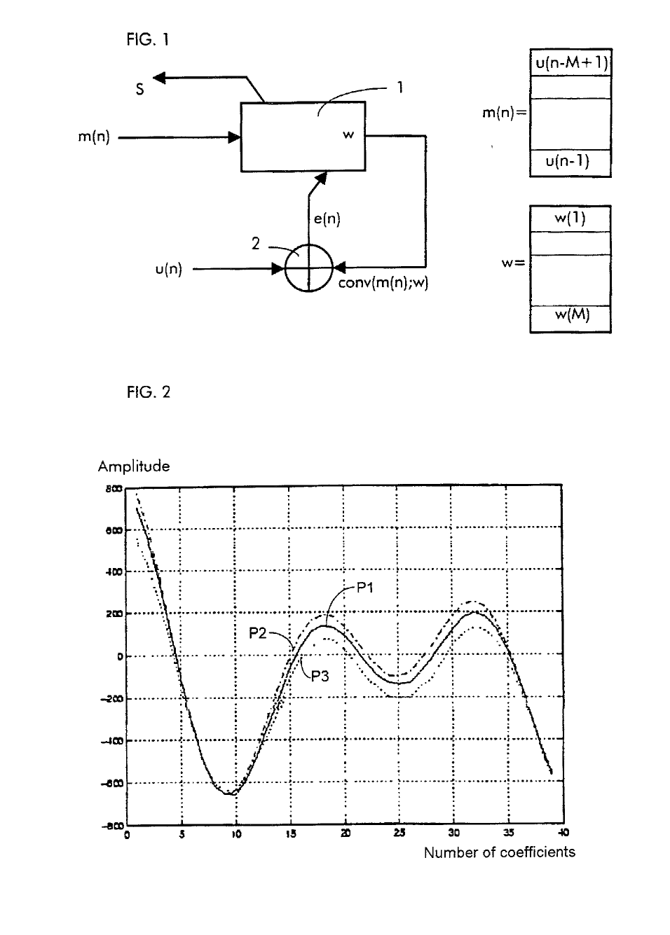

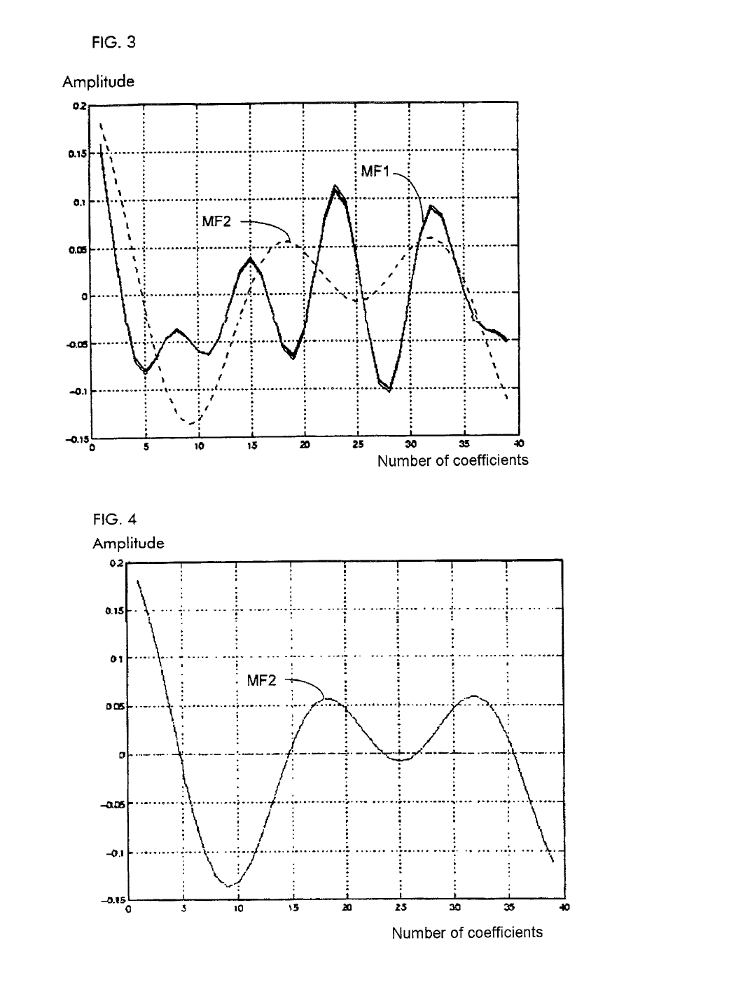

In FIG. 3 the multifrequency signal shown in FIG. 1 is accompanied by white noise.

The method in accordance with the invention of detecting a frequency or a combination of frequencies is intended for use in the field of telecommunications in particular, in which this kind of signal is used for telephone or mobile telephone signaling or for transmitting information. The single-frequency or multifrequency signals are processed by processing equipment incorporated into various real time telecommunication equipment units, in particular in the centers that constitute the various nodes of telecommunication networks. In this kind of application, the search to detect a particular frequency or combination of frequencies in a signal is applied to a signal that can be used to transmit speech, data, signaling, noise successively and/or simultaneously, and in particular in digital form. The search is then applied in a generally periodic manner to the spectrum of the signal to which the detection method is applied and yields an estimate of that signal. The estimate is obtained by taking into consideration a number of filter coefficients chosen according to what is required, for example.

The invention provides fast detection of the occurrence of a particular frequency or combination of frequencies in a signal to which the detection method is applied, assumed to be transmitted in the context of a real time application, by processing the signal using a signal processor programmed to use a lowest mean square (LMS) algorithm to estimate filter coefficients by means of which the spectrum of the signal can be defined.

On application of the method according to the invention, the first operation applied to the signal to which the detection method is applied is therefore to estimate each of the M filter coefficients wᵢ by means of which the spectrum of the signal can be defined. The number M is a positive integer chosen in a manner that is known in the art to obtain a particular spectral precision. The examples illustrated by the accompanying drawings relate to a number M=39 of coefficients.

The estimate is based on the LMS equations defined below:

ŵ(n+1)=ŵ(n)+μ.u(n).e(n) and

$$e ( n ) = u ( n ) - {\sum }_{k = 1}^{M} {\hat{w}}_{k} ( n ) \cdot u ( n - k )$$

in which

ŵ(n) is the estimate of the filter coefficients at time n, size M×1,

u(n) is the data vector, size M×1,

e(n) is an estimation error equal to e(n)=u(n)−û(n), size 1×1, and

μ is the algorithm step.

Assuming a power in the range from +3 dBm to −40 dBm for the signal to which the detection method is applied, it is possible to use the standardized LMS algorithm to compute the algorithm step parameter μ from the following equation:

$$μ = \frac{\tilde{μ}}{{‖ \underline{u} ( n ) ‖}^{2}}$$

Convergence of the algorithm can be obtained in 10 milliseconds for a value of \tilde{μ} equal to 0.2.

FIG. 1 is a simplified illustration of the LMS algorithm used by the detection method, in which m(n) is the signal to which the detection method is applied, which is fed to the input of a predictive filter 1. The input signal m(n) is defined by a set of data vectors u(n−M+1) to u(n−1), shown diagrammatically in FIG. 1, from which the estimation error e(n) is computed by means of an operator 2. To this end, the operator has a sample input receiving u(n) and an input receiving conv(m(n);w), which is supplied to it by the prediction filter 1, where, in this example, w corresponds to a set of M coefficients w(1) to w(M).

The output of the operator 2 is looped to an input of the predictive filter 1 to supply the computed estimation error defined by e(n) to the filter. That error, combined with the input signal defined by m(n), is used to obtain the spectrum of the input signal at an output S of the filter.

The adaptability of the filter in the face of variations in the input signal is a function of the sampling period. In a preferred embodiment of the invention, the estimated coefficients wᵢ are reinitialized every 10 milliseconds.

Using the three equations defined above to compute the algorithm step μ, the estimation errors e(n) and the filter coefficients ŵ(n) enables determination of each of the M filter coefficients retained for a particular frequency or combination of frequencies to be detected in the signal to which the detection method is applied.

In this embodiment, a series of M=39 filter coefficients is therefore obtained every 10 milliseconds from the signal to which the detection method is applied.

The power level of the signal to which the detection method is applied has virtually no influence on the level obtained for the various filter coefficients, as can be seen in FIG. 2, which corresponds to measurements effected for the same multifrequency signal comprising frequencies f1 and f2, for example 350 Hz and 440 Hz, and for three power levels P1, P2 and P3 of the signal to which the detection method is applied.

In this example the power levels P1, P2 and P3 are respectively −15 dBm, −5 dBm and −40 dBm and the corresponding amplitude variations for each of the 39 coefficients computed are not significant, as shown clearly by the three curves in the diagram.

Determining the coefficients enables selective detection of a frequency or a multifrequency combination, as shown in FIG. 3, which shows the values of the filter coefficients obtained for two close together multifrequency signals respectively represented by the curves MF1 and MF2. In this example the signal MF1 corresponds to the combination of two frequencies f1 and f2 referred to above, respectively 350 Hz and 440 Hz. The signal MF2 corresponds to a combination of two frequencies f1′ and f2′, respectively 700 Hz and 1 000 Hz.

In accordance with the invention, the presence of a single-frequency or multifrequency signal to be detected in an incoming signal is determined by a decision-making process based on an operation to compute the Euclidean distance between the signal to which the detection method is applied, at a given time, and the single-frequency or multifrequency signal to be detected.

The Euclidean distance d₁ (n) computed for a signal to which the detection method is applied and a signal consisting of a particular frequency or combination of frequencies is conventionally obtained from the following equation, taking into account M filter coefficients:

$${d}_{1} ( n ) = d ( \underline{w} ( n ) ; {\underline{w}}_{1} ) = {\sum }_{i = 1}^{M} {\vert {w}_{n} ( i ) - {w}_{1} ( i ) \vert}^{2}$$

It is compared to a predetermined threshold value d₀ chosen so that the particular frequency or combination of frequencies searched for can be considered to have been detected if the value of d₁ is less than the value of d₀.

In a preferred embodiment of the invention, the threshold value chosen is established by taking into account theoretical white noise coefficients.

To this end, two Euclidean distances are computed, one between the signal to which the detection method is applied and the single-frequency or multifrequency signal to be detected, as previously, and the other between the signal to which the detection method is applied and a white noise signal. Two series of coefficients respectively correspond to the predetermined filter coefficients w₁ for the single-frequency or multifrequency signal to be detected and the predetermined filter coefficients w₀ for the white noise signal.

FIG. 4 shows a multifrequency signal MF2, as envisaged in FIGS. 2 and 3, and the diagram gives the amplitude of the 39 predetermined filter coefficients w₁ characteristic of the signal. The white noise signal is represented on this scale by a horizontal curve at a very low level, practically coinciding with the abscissa axis of the diagram.

Two Euclidean distances d₁ and d₀ are computed, taking into account the estimated filter coefficients wₙ for the signal to which the detection method is applied and each of the two series of filter coefficients determined, i.e. the filter coefficients w₁ for the frequency or combination of frequencies to be detected and the filter coefficients w₀ for the white noise, as reflected in the following equations:

$${d}_{1} ( n ) = d ( \underline{w} ( n ) ; {\underline{w}}_{1} ) = {\sum }_{i = 1}^{M} {\vert {w}_{n} ( i ) - {w}_{1} ( i ) \vert}^{2}$$

$${d}_{0} ( n ) = d ( \underline{w} ( n ) ; {\underline{w}}_{0} ) = {\sum }_{i = 1}^{M} {\vert {w}_{n} ( i ) - {w}_{o} ( i ) \vert}^{2} = {\sum }_{i = 1}^{M} {\vert {w}_{n} ( i ) \vert}^{2}$$

Each of the two Euclidean distances computed gives an error estimate in relation to each of the two frequencies chosen. If the value of do is greater than the value of d₁, the frequency or combination of frequencies to be detected is considered to be present in the signal to which the detection method is applied and which has been processed.

It is of course feasible to consider reference signals other than the white noise signal instead of or in addition to the latter, in each case computing the Euclidean distance relative to each reference signal used.

The method according to the invention is more particularly intended to be used in telecommunication equipment and in particular in equipment in which its function is to detect multifrequency signals produced in response to operation of keypad keys. It can also be used in equipment to detect characteristic tones of specific steps reached during call processing, such as invitation to dial tones, busy tones, number unavailable tones, etc.

There is claimed:

1. A method of detecting a frequency or a combination of frequencies in a signal by processing said signal by means of an appropriate algorithm, which method includes an operation of estimating filter coefficients for characterizing said signal using a least mean squares algorithm and an operation of computing a Euclidean distance between said signal to which said detection method is applied and at least said frequency or combination of frequencies to be detected using said filter coefficients obtained for said signal to which said detection method is applied by said estimation operation and the same number of corresponding particular filter coefficients that characterize said frequency or combination of frequencies to be detected, said frequency or combination of frequencies being considered as having been detected in said signal to which said detection method is applied if the computed Euclidean distance is below a particular threshold value.

2. The method claimed in claim 1 wherein said threshold value corresponds to a Euclidean distance between said signal to which said detection method is applied and a particular signal normally included in said signal to which said detection method is applied, said distance being computed using said filter coefficients obtained for said signal to which said detection method is applied by said estimation operation and the same number of corresponding predetermined filter coefficients that characterize said particular signal.

3. The method claimed in claim 2 wherein said particular signal taken into account in determining said Euclidean distance constituting said threshold value is a white noise signal.

4. The method claimed in claim 1 including computing at least one additional Euclidean distance between said signal to which said detection method is applied and another particular signal likely to be contained in said signal to which said detection method is applied to constitute an additional threshold value which is compared with the estimated Euclidean distance between said signal to which said detection method is applied and said frequency or combination of frequencies to be detected.

5. Telecommunication equipment, in particular telephone and/or mobile telephone signaling processing equipment, including a signal processor programmed:
to estimate filter coefficients for characterizing a signal to which a detection method is applied by means of a least mean squares algorithm,
to compute a Euclidean distance between said signal to which said detection method is applied and at least said frequency or combination of frequencies to be detected using said filter coefficients obtained for said signal to which said detection method is applied by said estimation operation and the same number of corresponding particular filter coefficients that characterize said frequency or combination of frequencies to be detected, and
to provide a signal indicating that said frequency or said combination of frequencies has been detected in said signal to which said detection method is applied if the computed Euclidean distance is less than a particular threshold value.
